(19) United States
(12) Patent Application Publication
(10) Pub. No.: US 2007/0028037 A1
(43) Pub. Date: Feb. 1, 2007

(54) MEMORY SYSTEM WITH AUTOMATIC DUAL-BUFFERING

(75) Inventor: Eun-Suk KANG, Gyeonggi-do, (KR)

Correspondence Address: MARGER JOHNSON & MCCOLLOM, P.C., 210 SW MORRISON STREET, SUITE 400, PORTLAND, OR, 97204, US

(73) Assignee: Samsung Electronics Co., Ltd., Gyeonggi-Do (KR)

(21) Appl. No.: 11/383,162

(22) Filed: May 12, 2006

(30) Foreign Application Priority Data
Jul. 28, 2005 (KR) 2005-69128

(51) Int. Cl. G06F 13/00

(52) U.S. Cl. 711/104

(57) ABSTRACT

A memory device having a dual buffering scheme between a host and a memory core may include an address generator to automatically generate first and second addresses in response to an initial buffer-sector address. The host may access the dual buffer in response to the first address, while the memory core may simultaneously access the dual buffer in response to the second address.

### CROSS-REFERENCE TO RELATED APPLICATIONS

This application claims priority from Korean Patent Application 2005-69128, filed on Jul. 28, 2005, the entire contents of which are hereby incorporated by reference.

### BACKGROUND

NAND-type flash memory devices have high integration density and reserve data regardless of power supply conditions. Compared to random-access memories, NAND flash memory devices are relatively slow during read and write operations, and this may affect the performance of systems employing them. One type of flash memory device employs a NAND-type memory cell array with a NOR-type interface to retain the benefits of NAND memory while providing the higher access speeds of NOR-type flash memory. An example of such a hybrid device, which will be referred to herein as NOR-NAND memory, is Samsung's OneNAND® brand flash memory. NOR-NAND flash memory systems are usually operable with the input/output protocols of NOR-type flash memories (or static random-access memories). But NOR-NAND flash memory system embed a NAND flash memory core with a high integration density, a buffer RAM and register for high operation speed, and an error correction circuit (ECC), to provide large storage capacity, high frequency, and high stability. While employing high-frequency buffer RAMs, systems use dual-buffering schemes in order to assure high-frequency operation of NOR-NAND flash memories. The dual-buffering scheme prevents address conflicts on a bus between a host and a flash memory while transferring large volumes of data, e.g., volumes larger than the volume of the buffer. While loading data from the flash memory to a buffer RAM, the host may simultaneously be able to retrieve data from another buffer RAM that was previously loaded. Thus, it is possible to simultaneously load data from the flash memory to a buffer RAM and transfer data from another buffer RAM to the host, thereby assuring high-frequency operation and access to different buffer RAMs by different components of the system simultaneously.

Generally in a memory system, buffer addresses designate access patterns generated by a host interface and a flash interface (interfacing for the NAND flash core) for the buffer RAMs. In order for the host to retrieve data from the buffer RAM, the host designates addresses for the buffer RAM. According to the designated buffer addresses, the host interface decodes the addresses and applies the decoded addresses to the buffer RAM. The flash memory access the buffer RAM by generating start and end addresses with reference to values of buffer-sector address (BSA) and buffer-sector count (BSC) set by the host.

FIG. 1 is a timing diagram illustrating access patterns for the host and flash memory data transfer in a conventional dual-buffering operation. The timing diagram illustrates the procedure of retrieving (or reading) data from the flash memory by the host. First, the host sets a register for a dual-buffering operation. Then it writes flash memory addresses, DFS (dual flash selection), FBA (flash block address), FPA (flash sector address), and FSA (flash page address) for data to be loaded, to a start address register, and inputs buffer-RAM start addresses BSA (buffer sector address) and BISC (buffer sector count), which are temporarily loaded into the start address register. Thus, the start address register holds the flash memory addresses, DFS, FBA, FPA, and FSA, and the buffer sector address and count BSA and BSC. In response to a data-loading command and a low interrupt command INT, data stored at the designated flash-memory addresses are transferred from memory cells to page buffers during a time tR0 and then loaded from the page buffers into the buffer RAM during a time tT0. If all the data are loaded on a single buffer RAM, new flash-memory addresses DFS, FBA, FPS, and FSA are input to the start address register for loading in another buffer RAM. Further, it continues inputting a new buffer sector address and count, BSA and BSC, for loading more data and accepting a new data-loading command, then prosecuting the data loading operation. While loading data from the cell array to the page buffers and from the page buffers to a buffer RAM, data that have been already loaded into another buffer RAM are retrieved by the host that has the corresponding buffer-RAM addresses. With such an alternate buffer-RAM access by the host and the flash memory, a high volume of data is transferred in a high-frequency buffering mode without address conflicts.

The host is required to provide the buffer sector address and count, BSA and BSC, whenever loading data, in order to prepare the buffer RAM for the dual-buffering mode. In addition, the host is also required to provide the buffer-RAM addresses for every data access cycle to the host interface and the flash interface. These requirements for address inputs from the host for every data-loading step increase the burden of counting addresses in the host and cause delays in transferring data.

### SUMMARY

One aspect of the invention is a memory system comprising a memory core, a first interface configured to interface with the memory core, a second interface configured to interface with an external system, a buffer memory accessible by the first and second interfaces, and an address generation circuit configured to generate a first address used in accessing the buffer memory by the first interface and a second address used in accessing the buffer memory by the second interface in response to a first input buffer-sector address without an input of an additional buffer address. The memory core may have a plurality of data RAMs. The addresses may be generated in such a way that there is no conflict in accessing the data RAMs by the first and the second interfaces.

In another aspect of the invention, a memory system comprises; a memory core; a first interface configured to interface with the memory core; a second interface configured to interface with an external system; a buffer RAM accessible by the first and second interfaces; a register to receive a buffer address from the external system; a first address generator configured to generate a first address used in accessing the buffer RAM by the first interface in response to a first buffer-sector address that is input into the register; a second address generator configured to generate a second address used in accessing the buffer RAM by the second interface in response to the first buffer-sector address that is input into the register; and an address selection circuit to selectively supply one of the first and second addresses for the buffer RAM.

In one embodiment, the buffer memory may comprises first and second data RAMs. The first address may be generated to make the first interface alternately access the first and second data RAMs along time. The second address may be generated to make the second interface alternately access the first and second data RAMs. The address selection circuit may supply the first address to the buffer RAM in accessing the buffer RAM by the first interface, and may supply the second address to the buffer RAM in accessing the buffer RAM by the second interface.

Another aspect of the invention is a method of transferring large data in a NOR-NAND flash memory system including a host interface, a flash interface, firs and second buffers configured to buffer data between the host and flash interfaces, comprising the steps of: inputting a first buffer-sector address from an external system for transferring the large data; continuously generating a first buffer address accessed by the flash interface and a second buffer address accessed by the host interface, until completely transferring the large data, in response to the first buffer-sector address without an input of an additional buffer address from the external system.

### BRIEF DESCRIPTION OF THE DRAWINGS

FIG. 1 is a timing diagram illustrating a conventional dual-buffering operation.

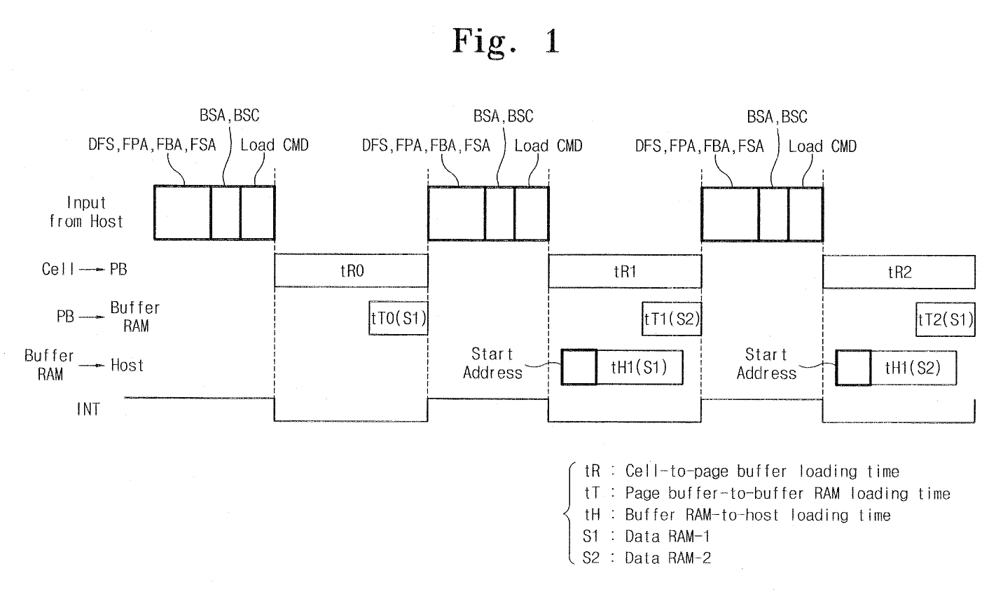

FIG. 2 is a block diagram illustrating an embodiment of an automatic dual-buffering buffer-RAM access in accordance with the invention.

FIG. 3 is a block diagram of an embodiment of an address generation circuit in accordance with the invention.

FIG. 4 is a timing diagram illustrating an embodiment of an automatic dual-buffering operation in accordance with the invention.

### DETAILED DESCRIPTION

Preferred embodiments of the invention will be described below in more detail with reference to the accompanying drawings. The invention may, however, be embodied in different forms and should not be constructed as limited to the embodiments set forth herein. Rather, these embodiments are provided so that this disclosure will be thorough and complete, and will fully convey the scope of the invention to those skilled in the art.

‘Large data’ described herein means data having a volume (or size) greater than that of a buffer RAM, which cannot be transferred through a one-step buffering operation, even when using the maximum capacity of the buffer RAM. Thus, reading or programming the large data may be accomplished using a plurality of buffering operation cycles.

‘Dual-buffering mode’ described herein means a mode for transferring data using two buffers (or buffer RAMs). Employing a single buffer for transferring large data is limited in speed because it is not possible to access the host and the flash interfaces at the same time. But using the two buffers enables high-frequency data transmission by employing bilateral access operations in which the host and flash interfaces are alternately connected to the two buffers.

Hereinafter, exemplary embodiments of the invention in conjunction with the accompanying drawings will be described.

In the dual-buffering mode according to an embodiment of the invention, the data loading operation from the flash memory core to the host and from the host to the flash memory core are mostly similar in nature, although there are some differences, such as the data transfer direction and address generation sequences. Hereinafter data-loading operation in one direction (from the flash memory core to ten host) will be described. However, the inventive principles apply to transferring data from the host to the flash memory core as well.

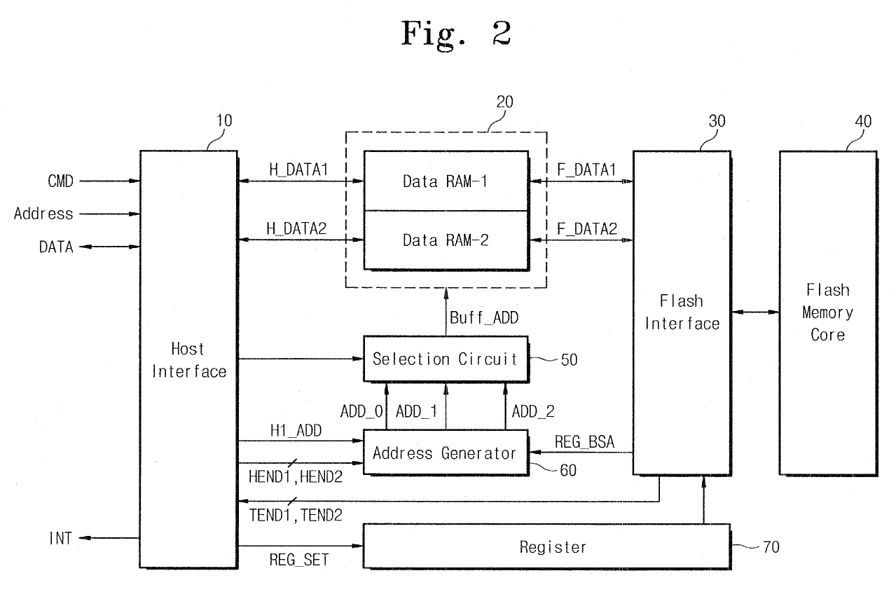

FIG. 2 is a block diagram illustrating an embodiment of an automatic dual-buffering buffer-PAM access in accordance with the inventive principles of this patent disclosure. Referring to FIG. 2, an NOR-NAND flash memory system employing the automatic dual-buffering mode includes a host interface 10 for interfacing with a host, a buffer RAM 20 for temporarily storing data transferred between the host interface 10 and a flash memory core 40, a flash interface 30 for controlling data transmission to/from the flash memory core 40, a selection circuit 50 for selecting buffer-RAM addresses, an address generation circuit 60 for providing addresses for accessing the buffer RAM by the host interface 10 and the flash interface 30, and a register 70 for accepting various set codes, commands, and addresses from the host.

The host interface 10 interfaces the host (e.g., a chip set or CPU) with the memory system. While the host interface 10 is not limited to a specific protocol, a general NOR-NAND flash memory system is usually implemented with an SRAM (or NOR flash memory) interface scheme. The host interface 10 controls general operations for loading data from the flash memory core 40 into the buffer RAM 20, and transferring the loaded data from the buffer RAM 20 to the host. Specifically, the host interface 10 is configured to automatically generate addresses for accessing the buffer RAM 20 by the flash interface 30 and the host interface 10, on the basis of a buffer sector address BSA while transferring large data. The host interface 10 detects transmission of data H_DATA1 and H_DATA2 to the host from the buffer RAM 20, and generates flag signals HEND. Further, the host interface 10 receives flash signals TEND from the flash interface 30, automatically converts data-RAM instruction bits of the buffer sector address BSA, and then outputs the instruction bits to the register 70.

The buffer RAM 20 is a high-frequency bilateral random access memory for temporarily storing data transferred between the host interface 10 and the flash interface 30. For the dual-buffering mode, the buffer RAM 20 includes two storage components: Data RAM-1 and Data RAM-2. Each data RAM is configured to be loaded in page units. As each data RAM has a plurality of sectors (for example, four sectors), so it is accessible in sector units. Data loaded by a one-time accessing cycle is determined in accordance with a BSC (buffer sector count). During a loading operation of large data, the flash interface 30 loads data in pages alternately to the Data RAM-1 and the Data RAM-2 in accordance with buffer selector address and count, BSA and BSC. The host interface 10 may be configured to transfer data to the host by alternately accessing the data RAM-1 and the data RAM-2 in accordance with the buffer sector address and count BSA and BSC. While a particular data-RAM is being loaded by the flash interface 30, it cannot be accessed by the host interface to transfer the data to the host. Similarly, when a particular data-RAM is accessed by the host interface 10 for transferring data to the host, the flash interface cannot load any data to that data-RAM. Hence, address generation for accessing the data-RAMs by the host and flash interfaces 10 and 30 should preferably be free of conflicts.

The flash interface 30 controls general data transmission between the buffer RAM 20 and the flash memory core 40 according to register set values, flash start addresses, DFS, FBA, FPA, 20 and FSA, and the buffer sector address and count BSA and BSC, initial values of which are received from the host. The flash interface 30 generates the buffer addresses accessed by itself with reference to an initial buffer address and count BSA and BSC received from the host. If data transmission is terminated between the buffer RAM 20 and the flash memory core 40, the flash interface 30 outputs flag signals TEND1 and TEND2 that inform the host interface 10 of an end to the data transmission. At the end of transmission of data F_DATA1 between the data RAM-1 and the flash memory core 40, the flag signal TEND1 is set to high by the flash interface 30. Similarly, at the end of transmission of data F_DATA2 between the data RAM-2 and the flash memory core 40, the flag signal TEND2 is set to high by the flash interface 30. The flag signals TEND1 and TEND2 are automatically referred by the host interface 10 while converting the data-RAM instruction bits of the buffer sector address (BSA), without inputting an additional buffer sector address from the host.

The flash memory core 40 may be a nonvolatile memory cell block for storing data. However, the inventive principles are not limited to any particular type of the memory core and the memory core 40 may be any type of NAND flash memories including memory cells, page buffers, and data buses. Flash addresses supplied from the host contain the flash block addresses (FBA), the flash page addresses (FPA), and the flash sector addresses (FSA). If the flash memory core 40 is a dual-type flash memory, the flash addresses from the host may additionally include the dual flash selection addresses (DFS). The flash addresses, FBA, FPA, FSA, or DFS are used by the flash interface 30 in programming data into the flash memory core 40 or loading data to the buffer RAM 20 from the flash memory core 40.

The selection circuit 50 supplies host access addresses ADD_{—0}, ADD_{—1}, and a flash access address ADD_{—2} from the address generation circuit 60 to the buffer RAM 20. Unless in the automatic dual-buffering mode, i.e. while operating in general dual-buffering mode, the host selects the address ADD_{—0} of the buffer RAM 20 for accessing it through the host interface 10. But in the automatic dual-buffering mode, the host selects the address ADD_{—1} of the buffer RAM 20 for accessing it through the host interface 10. When the flash interface 30 accesses the data RAM 20, the address ADD_{—2} is selected as the buffer address Buff_ADD. As aforementioned, the buffer address designation by the selection circuit 50 is accomplished by means of control signals provided by the host interface 10. Otherwise, the flash interface 30 may select the buffer address in accordance with a loading or transferring condition of each data RAM. The address designation by the selection circuit 50 may be implemented by means of a multiplexer or a logic circuit.

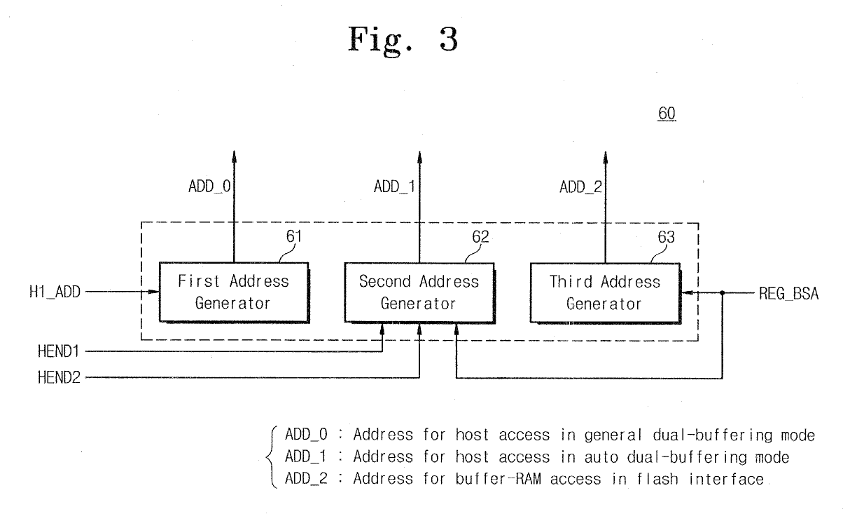

The address generation circuit 60 is configured to provide the addresses ADD_{—0} and ADD_{—1} for accessing the buffer-RAM 20 by the host interface 10, and the address ADD_{—2} for accessing the buffer RAM 20 by the flash interface 30. In a general dual-buffering mode, the buffer-RAM access address ADD_{—0} for the host interface 10 may be generated in response to an address H1_ADD supplied by the host. In the automatic dual-buffering mode, the address ADD_{—1} is generated with reference to the host flag signals, HEND1 and HEND2, supplied to the address generation circuit 60 by the host interface 10, and the first input buffer-sector address BSA. The buffer-RAM access address ADD_{—2}, for accessing the buffer RAM 20 by the flash interface 30, is generated on the basis of a buffer-sector address value stored in the register 70. The address generation circuit 60 according to the invention is represented as a single block in this embodiment, but it may be included into the host interface 10 or the flash interface 30, etc. An exemplary embodiment of the address generation circuit 60 will be further illustrated in FIG. 3.

The register 70 stores information like addresses, commands, configuration codes, interrupt state information etc. The buffer sector address BSA and buffer sector count BSC are used to configure the register for the dual-buffering mode. The flash interface 30 or another controller (not shown) refers to BSA and BSC for implementing an internal control scheme in the memory system. Most parts of the systemic configuration for the automatic dual-buffering mode are arranged when the memory system is booted. Otherwise, the automatic dual-buffering mode is set up by resetting the register while operating in a general dual-buffering mode. The buffer sector address and count, BSA and BSC, are supplied by the host and stored in the register 70 in order to generate buffer-RAM addresses for accessing the buffer RAM 20 by the flash interface 30. The following Table 1 shows exemplary code arrangements of the buffer sector address BSA for the buffer RAM, where each data RAM has four sectors.

TABLE 1

| Data RAM | Sector | BSA |
|---|---|---|
| Data RAM-1 | Data RAM-1_0 | 1000 |
| | Data RAM-1_1 | 1001 |
| | Data RAM-1_2 | 1010 |
| | Data RAM-1_3 | 1011 |
| Data RAM-2 | Data RAM-2_0 | 1100 |
| | Data RAM-2_1 | 1101 |
| | Data RAM-2_2 | 1110 |
| | Data RAM-2_3 | 1111 |

As shown in Table 1, the buffer sector address (BSA) is composed of 4 bits. The two higher bits of BSA correspond to the address for designating the data RAMs (i.e., the data-RAM instruction bits). For example, the address [10] designates the data RAM-1 while the address [11] designates the data RAM-2. The two lower bits of BSA correspond to the address for designating the sectors of the data RAMs. Each data RAM is composed of 4 sectors. The BSA initially stored in the register 70 is a start address to be accessed by the flash interface 30 at the initial time of operation in the automatic dual-buffering mode.

The following Table 2 summarizes exemplary values of the buffer sector count (BSC).

TABLE 2

| BSC | Sector count |
|---|---|
| 01 | 1 |
| 10 | 2 |
| 11 | 3 |
| 00 | 4 |

The buffer sector count BSC stores the sector number (i.e., sector count) to be accessed by the flash interface 30. In other words, the BSC restricts the data capacity permissible for a one-time access cycle. While the BSC is generally set to [00] as a default value in order to permit all the four sectors to be used therein, the data capacity for the one-time access may be restricted in accordance with the requirements of the host. In this embodiment of the invention, it is assumed that the BSC is set as the default value to permit all the four sectors of the data RAM to be used in loading large data.

The flash interface 30 accesses the buffer RAM 20 in compliance with the BSC set in the register 70. In addition, the host interface 10 detects a loading state of the buffer RAM 20 with a fist input of the BSA, establishing the address value of the BSA to designate the data RAM-1 or the data RAM-2. Even without an input of the BSA from the host, the host interface 10 internally generates the data-RAM instruction bits of the BSA in response to the flash flag signals TEND1 and TEND2 provided from the flash interface 30. The buffer address ADD_{—1} accessed by the host interface 10 is generated with reference to the host flag signals, HEND1 and HEND2. The signals HEND1 and HEND2 are generated by host interface 10 by detecting data transmission from the buffer RAM 20 and the BSA set in the register 70. Thus, the host interface 10 is able to internally generate buffer addresses using only the initial BSA and BSC, in sync with every input command for loading, thereby accomplishing the automatic dual-buffering operation.

FIG. 3 is a block diagram of an embodiment of the address generation circuit shown in FIG. 2. Referring to FIG. 3, the address generation circuit 60 according to the inventive principles of this patent disclosure includes first and second address generators, 61 and 62, which create addresses for accessing the buffer RAM 20 by the host interface 10, and a third address generator 63 which creates addresses for accessing the buffer RAM 20 by the flash interface 30.

The first address generator 61 is provided to generate address ADD_{—0} for accessing the buffer RAM 20 by the host interface 10 during general dual-buffering mode. The address ADD_{—0} is generated by decoding the signal H1_ADD from the host interface 10. In the general dual-buffering mode, the address H1_ADD must be input from the host in every access cycle in order to transfer data from the buffer RAM 20 to the host.

The second address generator 62 is provided to generate address ADD_{—1} for accessing the buffer RAM 20 by the host interface 10 during the auto dual buffering mode. The second address generator 62 is configured to generate the address ADD_{—1} under the control of the host interface 10, without an address input from the host interface 10 at every access cycle. The second address generator 62 is configured so that the generated address ADD_{—1} does not conflict with the buffer address for accessing the buffer RAM by the flash interface 30, with reference to a buffer sector address REG_BSA read out from the register 70. If data loaded on the data RAM-1 are all transferred to the host, the host interface 10 outputs the host flag signal HEND1 to inform the second address generator 62 that all the data of the data RAM-1 have been transferred to the host. Then, the second address generator 62 converts the buffer address, which is to be accessed later by the host interface 10, to be assigned to the data RAM-2. If all data of the data RAM-2 are transferred to the host, the host interface 10 issues the host flag signal HEND2 to the second address generator 62. Then, the second address generator 62 changes the address ADD_{—1} and assigns it to data RAM_{—1}. In transferring the large data, such a procedure is repeated until all the data are completely transferred, thus carrying out the automatic dual-buffering operation.

The third address generator 63 is provided to generate the address ADD_{—2} for accessing the buffer RAM 20 by the flash interface 30. In general, the flash interface 30 accesses the buffer RAM 20 on the basis of the buffer address and count BSA and BSC that are initially set on the register 70. The third address generator 63 outputs the buffer address ADD_{—2} with reference to the buffer sector address REG_BSA that is read out from the register 70 by the flash interface 30, designating the data RAM and associated sector to be accessed by the flash interface 30. The buffer sector address (BSA) set on the register 70 determines the data RAM and sector accessed by the flash interface 30.

In the automatic dual-buffering mode according to the inventive principles of this patent disclosure, the second and third address generators, 62 and 63, are controlled by the host interface 10. If there is an input with the first buffer sector address and count BSA and BSC, the buffer addresses for the dual-buffering mode are automatically generated by the host interface 10, the second address generator 62, and the third address generator 63. Responding to the flash flag signals TEND1 and TEND2 provided from the flash interface 30 to inform a data loading state, the host interface 10 conducts the automatic dual-buffering operation for the large data with alternately accessing the data RAM-1 and the data RAM-2.

While the address generation circuit 60 is illustrated as being a separate unit, the implementation may vary. For instance, the address generation circuit 60 may be included in the host interface 10, or in the flash interface 30. Alternatively, the first and second address generators, 61 and 62, may be integrated in the host interface 10, while the third address generator 63 may be integrated in the flash interface 30.

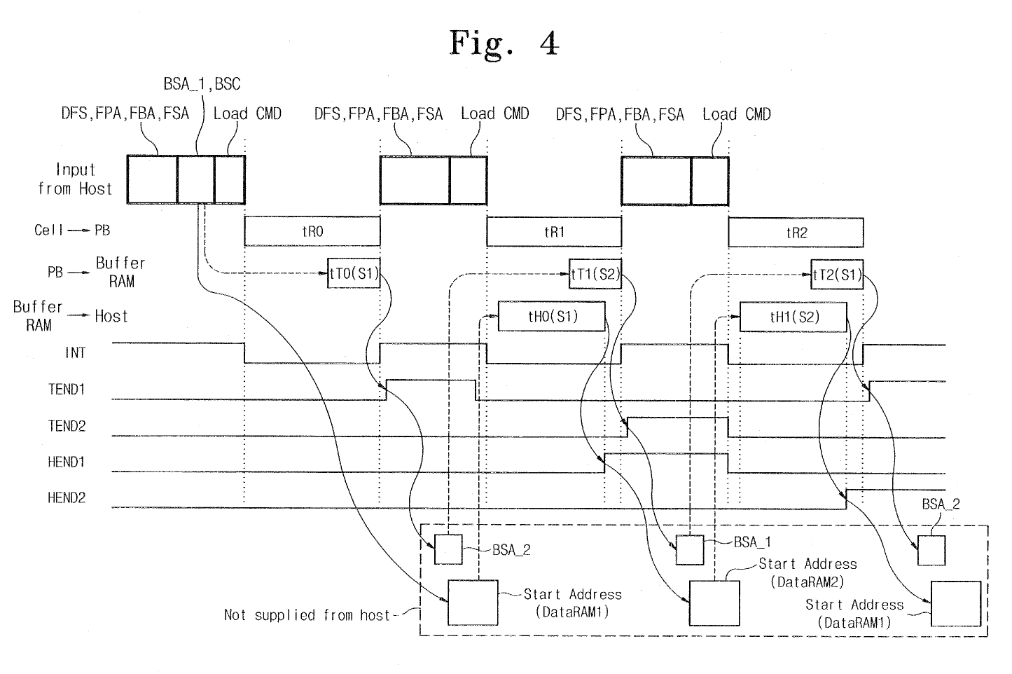

FIG. 4 illustrates a timing diagram for an embodiment of an automatic dual-buffering operation according to the inventive principles of this patent disclosure. The timing diagram illustrates the operation of loading large data with reference to FIG. 2. FIG. 4 shows addresses and commands input to the host interface 10 by the host, a data transmission time tR for transferring data from the flash memory cells to the page buffers, a transmission time tT for transferring data from the page buffers to the buffer RAM 20, a transmission time tH for transferring data from the buffer RAM 20 to the host, and flag signals, HEND1, HEND2, TEND1 and TEND2, that are generated when data are completely transferred through the interrupt pin INT, the host interface 10, and the flash interface 30.

When loading large data from the flash memory core 40 to the host, the flash start addresses, DFS, FBA, FPA, and FSA, for the data to be read out from the flash memory core 40 are written in the register 70. Then the initial buffer sector address and count, BSA and BSC, are supplied to the register 70. Thereafter, a loading command (load CMD) and a low interrupt signal (i.e., the interrupt pin INT) are input to the register 70.

If the interrupt signal INT transitions to low, the flash interface 30 loads data from the flash memory core 40 to the page buffers, responding thereto, in accordance with the start address (tR0). This operation is carried out whenever the flash start address is input thereto. The unit page data previously loaded on the page buffers are transferred to the buffer RAM 20. The operation shown in FIG. 4 is proceeding on the assumption that the first address of BSA is input as BSA_{—1} to make the data RAM-1 assigned therewith. Thus, a first data-loading operation is carried out from the page buffers to the data RAM-1 (S1) for the time tT0. If all the data are transferred to the data RAM-1 from the page buffers, the interrupt signal INT goes high.

Completing the first data-loading operation from the page buffers to the data RAM-1, the host detects the condition of the interrupt pin INT and applies the flash start addresses, DFS, FBA, FPA, and FSA, and the loading command (load CMD) to the register 70 to proceed with the data loading sequence. At this time, there is no input of the next buffer address for accessing the buffer RAM 20 by the flash interface 30. Further, there is no input of a start address for transferring data from the data RAM-1 (S1) to the host. The next buffer address BSA_{—2 for loading data from the page buffers by the flash interface 30 is supplied from the third address generator 63, for which the data-RAM instruction bits of the first input buffer address BSA-1 are converted to be the buffer address BSA}_{—2}. A start address for accessing the data RAM-1 (S1), which has loaded data thereon during the time tT0 (S1), by the host is generated with reference to the first BSA which is BSA_{—1} that has already been generated by the second address generator 62. Then, the data are transferred to the host from the data RAM-1 during time tH0 (S1).

When the data-loading operation from the page buffers of the flash memory core 40 to the buffer RAM 20 is completed (tT1), the flash interface 30 generates the flash flag signal TEND2, which signals the end of loading the data RAM-2. The flash flag signal TEND2 is sent to the host interface 10. The host interface 10 generates the buffer sector address BSA_{—1} in response to the flash flag signal TEND2, for selecting the data RAM-1 as the next data RAM to be accessed by the flash interface 30, and applies the address BSA_{—1} to the register 70. The buffer sector address BSA_{—1} is established by changing the data-RAM instruction bits of the address BSA_{—2}. Also, when the transmission of the data from the buffer RAM 20 to the host is complete (tH0), the host interface 10 generates the host flag signal HEND1 and applies the host flag signal HEND1 to the address generation circuit 60. The second address generator 62 of the address generation circuit 60 outputs a start address, with reference to the host flag signal HEND1, to select the data RAM-2 as the buffer RAM to be accessed by the host interface 10 thereafter. Through repetition of the aforementioned operation, the large data are continuously loaded to the buffer RAM 20 from the flash memory core 40 and thereby the loaded data of the buffer RAM 20 are continuously transferred to the host.

It can be seen that the first buffer sector address BSA_{—1} is used to generate the buffer sector addresses, BSA_{—1} and BSA_{—2}, for accessing the buffer RAM 20 by the flash interface 30, and the start address for accessing the buffer RAM 20 by the host interface 10. Thus, the addresses for accessing the buffer RAM 20 are automatically generated from the initial one-time input of the buffer sector address (BSA) for the large data, accomplishing the automatic dual-buffering mode. This procedure is repeated until reading or programming the large data is completed.

Although the above embodiments describe dual-buffering mode for transferring data in a single direction, it may be understood by those skilled in the art that the invention is also applicable to a data transfer operation in a different direction.

The invention may be helpful in reducing operational burdens for a chipset or a CPU as there is no need to accept a buffer sector address from the host for every access, thereby decreasing input time for the buffer sector address and enhancing data transmission speed. The invention may provide a memory system operable in a dual-buffering mode without a need for inputting buffer-RAM addresses from a host during every access while loading a large amount of data, i.e., larger than the volume of the buffer RAM. With systems and methods according to embodiments of the invention, it may be able to assist an automatic dual-buffering mode by generation of addresses for internally accessing the buffers just by means of accepting the first sector address from the host in loading or programming a large amount of data.

The invention has been described using exemplary embodiments; however, it will be understood that the scope of the invention is not limited to only the disclosed embodiments. Rather, the scope of the invention is intended to encompass various modifications and similar arrangements. The scope of the claims, therefore, should be accorded the broadest interpretation so as to encompass all such modifications and similar arrangements.

1. A memory system comprising:
a memory core;
a first interface configured to interface with the memory core;
a second interface configured to interface with an external system;
a buffer memory accessible by the first and second interfaces; and
an address generation circuit configured to generate a first address used in accessing the buffer memory by the first interface and a second address used in accessing the buffer memory by the second interface in response to a first input buffer-sector address without an input of an additional buffer sector address.

2. The memory system of claim 1, wherein the buffer memory comprises first and second data RAMs.

3. The memory system of claim 2, wherein the first and second addresses alternately designate the first and second data RAMs.

4. The memory system of claim 3, wherein the first address is generated to make the first interface alternately access the first and second data RAMs.

5. The memory system of claim 4, wherein the second address is generated to make the second interface alternately access the first and second data RAMs.

6. The memory system of claim 2, where the first and the second address at any given time refers to different data RAMs.

7. The memory system of claim 1, wherein the memory system comprises a flash memory system.

8. The memory system of claim 7, wherein the memory system comprises a NOR-NAND flash memory system.

9. A memory system comprising:
a memory core;
a first interface configured to interface with the memory core;
a second interface configured to interface with an external system;
a buffer RAM accessible by the first and second interfaces;
a register to receive a buffer address from the external system;
a first address generator configured to generate a first address used in accessing the buffer RAM by the first interface with reference to a first buffer-sector address that is input into the register;
a second address generator configured to continuously generate a second address used in accessing the buffer RAM by the second interface with reference to the first buffer-sector address that is input into the register; and
an address selection circuit to selectively supply the first and second addresses for the buffer RAM.

10. The memory system of claim 9, wherein the buffer RAM comprises first and second data RAMs.

11. The memory system of claim 10, wherein the first address is generated to make the first interface alternately access the first and second data RAMs.

12. The memory system of claim 10, wherein the second address is generated to make the second interface alternately access the first and second data RAMs.

13. The memory system of claim 8, wherein the memory system comprises a NOR-NAND flash memory system.

14. A method of transferring large data in a NOR-NAND flash memory system that includes a host interface, a flash interface, and first and a second buffers configured to buffer data between the host and flash interfaces, the method comprising:
inputting a first buffer-sector address from an external system for transferring the large data;
continuously generating a first buffer address accessed by the flash interface and a second buffer address accessed by the host interface in response to the first buffer-sector address without an input of an additional buffer-sector address from the external system, until the large data is completely transferred between the host and flash interfaces.

15. The method of claim 14 where the large data is transferred from the flash interface to the host interface.

16. The method of claim 14 where the large data is transferred from the host interface to the flash interface.

17. The method of claim 14, wherein the first buffer-sector address, the first buffer address, and the second buffer address include bit values for instructing the first and second buffers.

18. The method of claim 14, wherein the first buffer address is generated to make the flash interface alternately access the first and second buffers while transferring the data.

19. The method of claim 18, wherein the second buffer address is generated to make the host interface alternately access the first and second buffers while transferring the data.

20. The method of claim 17, wherein the bit values for instructing the first and second buffers are determined in response to a data condition from the flash interface in the first buffer address, and determined in response to a data condition from the host interface in the second buffer address.

21. The method of claim 14, wherein the large data is larger than the storage capacities of the first and the second buffers.

22. The method of claim 21, wherein the first buffer-sector address is supplied by the external system every time large data is transferred.

23. A memory system comprising:
a memory core;
a first interface configured to interface with the memory core in response to a first address;
a second interface configured to interface with an external system in response to a second address;
a buffer memory simultaneously accessible by the first and second interfaces; and
an address generation circuit to automatically generate the first and second addresses in response to an initial buffer-sector address.

24. The memory system of claim 23 wherein the address generation circuit is separate from the first and second interfaces.

25. The memory system of claim 23 wherein the address generation circuit is integral with the first and/or second interface.

26. The memory system of claim 23 further comprising an address selection circuit to selectively supply the first and second addresses to the buffer memory.

27. The memory system of claim 23 further comprising a register to receive a buffer address from the external system.
